(19) United States
(12) Patent Application Publication
(10) Pub. No.: US 2013/0038716 A1
(43) Pub. Date: Feb. 14, 2013

(54) METHOD OF INSPECTING A MASK AND APPARATUS FOR PERFORMING THE SAME

(71) Applicants: WonIl CHO, Seongnam-si (KR); Dong-Hoon CHUNG, Yongin-si (KR); Ji-Hoon NA, Bucheon-si (KR); Sang-Hoon HAN, Seoul (KR)

(72) Inventors: WonIl CHO, Seongnam-si (KR); Dong-Hoon CHUNG, Yongin-si (KR); Ji-Hoon NA, Bucheon-si (KR); Sang-Hoon HAN, Seoul (KR)

(73) Assignee: SAMSUNG ELECTRONICS CO., LTD., Suwon-si (KR)

(21) Appl. No.: 13/552,169

(22) Filed: Jul. 18, 2012

(30) Foreign Application Priority Data
Aug. 9, 2011 (KR) 10-2011-0078845

(51) Int. Cl. G01N 21/956; H04N 7/18

(52) U.S. Cl. 348/126; 356/237.5

(57) ABSTRACT

In a method of inspecting a mask, an image of a first die in a corrected mask may be obtained. The corrected mask may be corrected using correction data that may include deformation factors related to an exposure process. The first image may be reversely corrected based on correction data. The reversely corrected first image may be compared with a reference image to determine whether the first die may be properly implemented or not.

### CROSS-RELATED APPLICATION

This application claims priority under 35 USC §119 to Korean Patent Application No. 2011-78845, filed on Aug. 9, 2011 in the Korean Intellectual Property Office (KIPO), the contents of which are herein incorporated by reference in their entirety.

### BACKGROUND

1. Field

Exemplary embodiments in accordance with principles of inventive concepts relate to a method of inspecting a mask and an apparatus for performing the same. More particularly, exemplary embodiments in accordance with principles of inventive concepts relate to a method of inspecting an extreme ultraviolet (EUV) mask, and an apparatus for performing the inspection.

2. Description of the Related Art

As semiconductor design rules have progressed minimal feature sizes have been reduced and the wavelength of light used in an exposure process has also been reduced. Because a desired pattern featuring minimal widths may not be formed using a light such as an I-line, a G-line, a KrF, an ArF, etc., an extreme ultraviolet (EUV) light, having a short wavelength, may be used in an exposure process.

However, because the EUV light may have high energy, a substantial portion of the EUV light may be absorbed in an absorbing layer of an EUV mask, so that a substantial portion of the EUV light may not reach a semiconductor substrate. For this reason, and others, a reflective EUV mask for using a reflected EUV light may be employed in a photolithographic process.

A reflective EUV mask may be used to transcribe a multi-die pattern into a photoresist film on a semiconductor substrate by an exposure process that forms a desired photoresist pattern. The shape of the etched pattern is dependent upon the accuracy of the mask pattern in the reflective EUV mask and, in order to ensure that the pattern is accurately etched the mask pattern of the reflective EUV mask may be inspected. The inspection process may entail comparing dies of the same design on the reflective EUV mask with one another, or comparing dies, with a design pattern input into an inspecting apparatus.

Because EUV light may deform the shape of a mask, mask features may not be accurately transcribed into a photoresist film. To ensure proper feature formation on the target semiconductor, the mask pattern may require correction, or compensation, for such deformation.

However, compensating the mask pattern may deform the shape of a die image, preventing the use of a die reference for direct comparison.

### SUMMARY

Exemplary embodiments in accordance with principles of inventive concepts provide a method of inspecting a mask that may be capable of comparing a corrected, or pre-compensated, mask with a reference.

Exemplary embodiments in accordance with principles of inventive concepts also provide an apparatus for performing the above-mentioned method.

According to some exemplary embodiments in accordance with principles of inventive concepts, there is provided a method of inspecting a mask. In an exemplary embodiment of a method of inspecting a mask, a first actual image of a first die in a corrected mask may be obtained. That is, an image of a die within a precompensated mask may be obtained. A corrected mask may be corrected using correction data that may include deformation factors in an exposure process. That is, the precompensated mask may have been compensated using compensation data such as deformation factors related to an exposure process. The first actual image may be reversely corrected based on the correction data. That is, the image of the die may be decompensated using the compensation data. The reversely corrected first actual image may be compared with a reference image to determine whether the first die may be normal or not. That is, the decompensated image may be compared with a reference, such as a reference image, to determine whether the mask meets design specifications.

In exemplary embodiments in accordance with principles of inventive concepts, correction data may include data of horizontal-vertical bias (h-v bias) caused by a wavelength of an EUV light in an exposure process, data of a flare of the EUV light in the exposure process, or other data, for example.

In exemplary embodiments in accordance with principles of inventive concepts, a method may further include obtaining an image of a second die adjacent to the first die, reversely correcting (that is, decompensating) the image of the second die based on correction data (also referred to herein as compensation data), and setting the reversely corrected (that is, decompensated) second image as the reference image.

In exemplary embodiments in accordance with principles of inventive concepts, the reference image may include a design image of the mask.

In exemplary embodiments in accordance with principles of inventive concepts, comparing the reversely corrected first image with the reference image may include detecting a defect in the reversely corrected first image.

In exemplary embodiments in accordance with principles of inventive concepts, comparing the reversely corrected first image with the reference image may include measuring a critical dimension uniformity of the reversely corrected first actual image.

According to some exemplary embodiments in accordance with principles of inventive concepts, there is provided an apparatus for inspecting a mask. The apparatus may include an image-obtaining unit, a reversely image-correcting unit and an inspecting unit. The image-obtaining unit may obtain images of dies in a corrected mask that may be corrected using correction data that may include deformation factors in an exposure process. The reversely image-correcting unit may reversely correct the images based on the correction data. The inspecting unit may compare the reversely corrected images with a reference image to determine whether the dies may be normal or not.

In exemplary embodiments in accordance with principles of inventive concepts, the inspecting unit may include a defect-detecting member for detecting a defect in the reversely corrected actual images.

In exemplary embodiments in accordance with principles of inventive concepts, the inspecting unit may include a critical dimension-measuring member for measuring a critical dimension (CD) uniformity of the reversely corrected actual images.

According to some exemplary embodiments in accordance with principles of inventive concepts, the corrected image of the mask, which may be corrected using the correction data, may be reversely corrected based on the correction data. Thus, the reversely corrected image may have a shape comparable with the reference image.

According to exemplary embodiments in accordance with principles of inventive concepts, a mask inspection system includes an imager configured to obtain an image of a die in a mask; a decompensator configured to decompensate the image of the die; and a comparator configured to compare the decompensated image of the die to a reference image. The decompensator may be configured to decompensate EUV compensated masks and may decompensate h-v or flare compensation, for example. The comparator may compare a decompensated mask image to a reference represented by design data or by another mask image, for example.

### BRIEF DESCRIPTION OF THE DRAWINGS

Exemplary embodiments in accordance with principles of inventive concepts will be more clearly understood from the following detailed description taken in conjunction with the accompanying drawings. FIGS. 1 to 6 represent non-limiting, exemplary embodiments in accordance with principles of inventive concepts as described herein.

FIG. 1 is a block diagram illustrating an apparatus for inspecting a mask in accordance with exemplary embodiments in accordance with principles of inventive concepts;

FIG. 2 is a flow chart illustrating a method of inspecting a mask using the apparatus in FIG. 1 in accordance with principles of inventive concepts;

FIG. 3 is a picture showing an actual mask;

FIG. 4 is a map picture showing correction data;

FIG. 5 is a map picture showing a mask obtained by reversely correcting the actual mask in FIG. 3 based on the correction data in FIG. 4; and

FIG. 6 is a flow chart illustrating a method of inspecting a mask using the apparatus in FIG. 1 in accordance with exemplary embodiments in accordance with principles of inventive concepts.

### DETAILED DESCRIPTION OF THE EMBODIMENTS

Exemplary embodiments of the inventive concepts will now be described more fully with reference to the accompanying drawings, in which exemplary embodiments of the inventive concept are shown. Exemplary embodiments of the inventive concept may, however, be embodied in many different forms and should not be construed as limited to the embodiments set forth herein; rather, these exemplary embodiments of the inventive concept are provided so that this description will be thorough and complete, and will fully convey the concept of exemplary embodiments of the inventive concept to those of ordinary skill in the art. In the drawings, the thicknesses of layers and regions are exaggerated for clarity. Like reference numerals in the drawings denote like elements, and thus their description will be omitted.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. As used herein, the term “and/or” includes any and all combinations of one or more of the associated listed items. Other words used to describe the relationship between elements or layers should be interpreted in a like fashion (e.g., “between” versus “directly between,” “adjacent” versus “directly adjacent,” “on” versus “directly on”).

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the inventive concept.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated, for example, 90 degrees or at other orientations) and the spatially relative descriptors used herein interpreted accordingly.

The terminology used herein is for the purpose of describing particular exemplary embodiments of the inventive concept only and is not intended to be limiting of the inventive concept. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Exemplary embodiments of the inventive concept are described herein with reference to cross-sectional illustrations that are schematic illustrations of idealized exemplary embodiments of the inventive concept (and intermediate structures). As such, variations from the shapes of the illustrations as a result, for example, of manufacturing techniques and/or tolerances, are to be expected. Thus, exemplary embodiments of the inventive concept should not be construed as limited to the particular shapes of regions illustrated herein but are to include deviations in shapes that result, for example, from manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the figures are schematic in nature and their shapes are not intended to illustrate the actual shape of a region of a device and are not intended to limit the scope of the present inventive concept.

Unless otherwise defined, all terms (including technical and scientific terms) used herein have the same meaning as commonly understood by one of ordinary skill in the art to which this inventive concept belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, exemplary embodiments in accordance with principles of inventive concepts will be explained in detail with reference to the accompanying drawings.

Apparatus for Inspecting a Mask

FIG. 1 is a block diagram illustrating an apparatus for inspecting a mask in accordance with principles of inventive concepts. An apparatus 100 for inspecting a mask in accordance with an exemplary embodiment may include an image-obtaining unit 110 (also referred to herein as an imager 110), a reversely image-correcting unit 120 (also referred to herein as a decompensation unit 120) and an inspecting unit 130 (also referred to herein as comparator 130).

In exemplary embodiments in accordance with principles of inventive concepts, a reflective EUV mask may include a plurality of die patterns, each of which may be of the same design (e.g., each die pattern may be for one of a plurality of integrated circuit devices to be formed on a wafer). The reflective EUV mask may include a mask substrate, a reflective layer formed on the mask substrate, and an absorbing layer pattern formed on the reflective layer, for example.

During an exposure process using an EUV light, the mask pattern of the reflective EUV mask may not be accurately transcribed into a photoresist film due to a bias, a flare, etc. Thus, before the exposure process, it may be required to correct a shape of the mask pattern of the reflective EUV mask based on influences of the bias, the flare, etc. A corrected reflective EUV mask may have a deformed shape. That is, because an EUV mask may be distorted during use in a photolithographic process, the mask may be pre-compensated to accommodate such distortions, with the end result being that operational distortions deform the pre-compensated mask into a pattern that is as designed for the photolithographic process.

The image-obtaining unit 110 may obtain an image of a die on the corrected, or pre-compensated, reflective EUV mask. In exemplary embodiments in accordance with principles of inventive concepts, image-obtaining unit 110 may include a charge coupled device (CCD) camera arranged over the EUV mask to photograph one or more of the die areas within the mask.

In exemplary embodiments in accordance with principles of inventive concepts, images of die mask patterns before a correction process may be substantially the same as one another or as a design image input into apparatus 100. However, images of die mask patterns after the correction process (that is, after pre-compensation) may be different from one another and from a design image. Therefore, it may not be possible to determine whether a mask pattern may yield the correct results in use (that is, yield a desired photolithographic pattern) by comparing images of the corrected die mask patterns with each other or with a design image.

The reversely image-correcting unit 120 (or, decompensation unit 120) may reversely correct images obtained by image-obtaining unit 110 based on correction data. Reversely corrected images may have substantially the same shape, or a shape comparable with, a reference image. Correction data may be inputted into reversely image-correcting unit 120 to be used in comparisons. That is, decompensation unit 120 may employ image correction data (that is, data used to pre-compensate the mask) to decompensate images obtained by imaging unit 110 in order to compare an image of an EUV mask to a standard.

In exemplary embodiments in accordance with principles of inventive concepts, the correction data may include deformation factors in a photolithographic exposure process. The correction data may correspond to data used for correcting (that is, precompensating for) deformations of patterns on a semiconductor substrate caused by the exposure process using the EUV light, for example. Correction data may include data related to horizontal-vertical bias caused by a wavelength of an EUV light in an exposure process, data of a flare of EUV light in the exposure process, etc.

Inspecting unit 130 may compare reversely corrected actual images of the die mask patterns (that is, decompensated die mask pattern images) with each other to determine whether the die mask patterns may be within specified tolerances. In such an embodiment, the reference image may be an image of a die that has been pre-compensated to accommodate EUV distortions, with the image decompensated. Alternatively, inspecting unit 130 may compare a decompensated image, such as a die image, with a design image in inspecting unit 130 to determine whether the mask patterns may be correctly implemented.

In exemplary embodiments in accordance with principles of inventive concepts, inspecting unit 130 may include a defect-detecting member 132 and a critical dimension (CD)-measuring member 134. Defect-detecting member 132 may compare a decompensated image with a reference image to detect any defects that may exist in the decompensated image. CD-measuring member 134 may measure a CD of a decompensated image. CD-measuring member 134 may compare a measured CD of a decompensated image with a CD of a reference image to obtain a measure of CD uniformity of a mask image.

Method of Inspecting a Mask

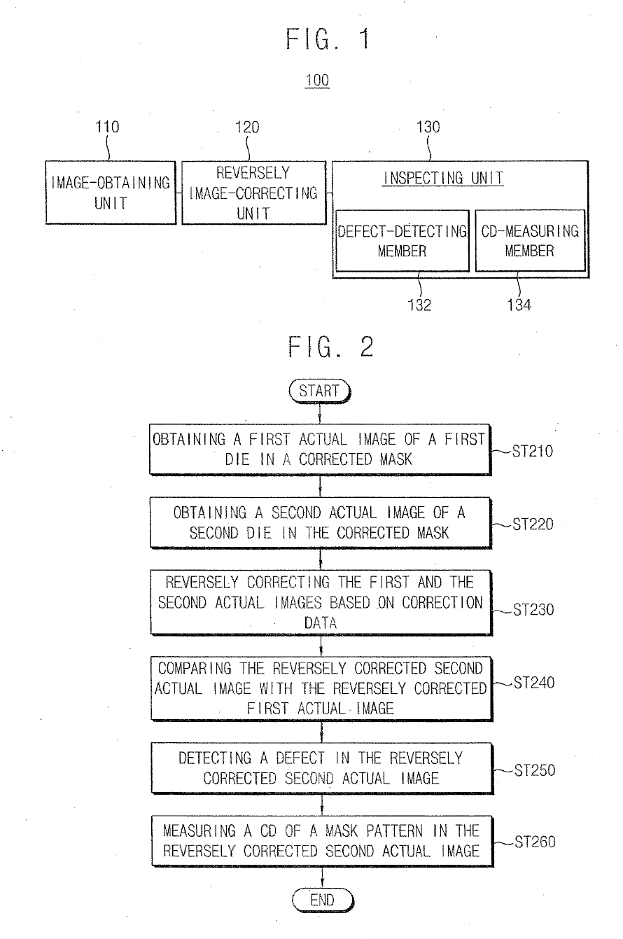

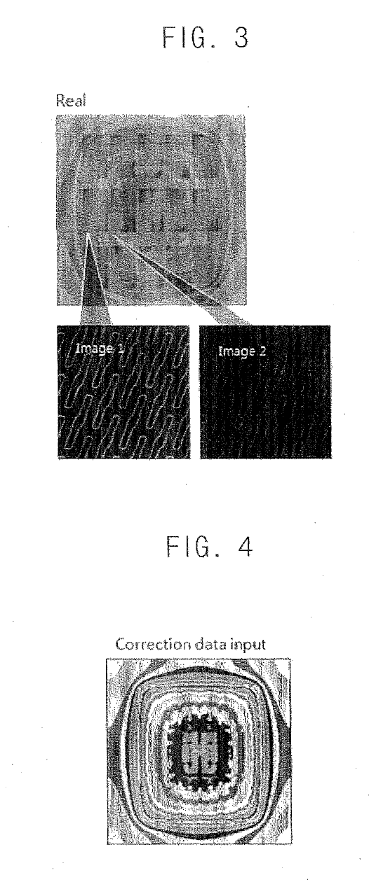

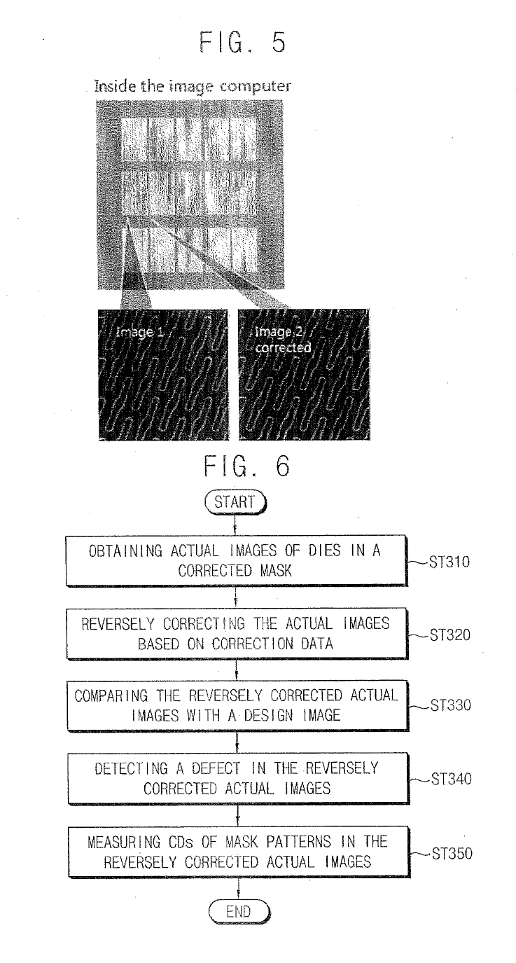

FIG. 2 is a flow chart illustrating a method of inspecting a mask in accordance with principles of inventive concepts using the apparatus in FIG. 1. FIG. 3 is an image showing a reflective EUV mask. FIG. 4 is a map image illustrating correction data. FIG. 5 is a map image illustrating a mask obtained by reversely correcting (that is, decompensated) the mask in FIG. 3 based on the correction data in FIG. 4.

Referring to FIGS. 1 and 2, in step ST210, image-obtaining unit 110 may obtain an image of a first die in a pre-compensated mask.

In step ST220, image-obtaining unit 110 may obtain an image of a second die in the pre-compensated mask.

In exemplary embodiments in accordance with principles of inventive concepts, dies of the mask may have mask patterns having shapes substantially the same as each other. That is, a mask may include a plurality of dies of the same design, which may be used to form a plurality of semiconductor devices having all of the same design on a single semiconductor wafer. As shown in FIG. 3, the mask may be corrected, that is, pre-compensated, based on correction, or compensation, data that accounts for distortions of the mask that may be caused by the EUV irradiation. As shown in FIG. 4, correction data may correspond to data used for correcting deformations of a pattern on a semiconductor substrate caused by an exposure process using an EUV light. The correction data may include data of horizontal-vertical (h-v) bias caused by a wavelength of an EUV light in the exposure process, data of a flare of the EUV light in the exposure process, or other distortions, for example.

In an h-v bias correction process, during the exposure process for forming a photoresist pattern by transcribing the mask pattern into a photoresist film using the EUV light, bias may exist in the photoresist pattern along a vertical direction and a horizontal direction due to oblique incident reflective light. Thus, the photoresist pattern may have a shape different from that of the mask pattern. In order to correct for the deformation of the photoresist pattern, a bias may be applied to the mask along the vertical direction and the horizontal direction with respect to a center point of the mask to correct, or pre-compensate, the shape of the mask to ensure that the photoresist pattern is the designed photoresist pattern despite the effects of h-v bias.

In a flare correction process, the flare may influence all of regions of a mask during the exposure process using EUV light. The flare may cause inaccurate transcription of the mask pattern. Therefore, the shape of the mask may be corrected, or pre-compensated, based on the influence of the flare to ensure that the photoresist pattern is the designed photoresist pattern despite the effects of flare.

As shown in FIG. 3, mask patterns in individual dies of the mask may have different shapes due to the precompensation that have adjusts for h-v bias and flare. As a result, it may be impossible to determine whether the dies within the mask may yield the correct pattern during a photolithographic process by comparing images of dies within the mask.

In step ST230, the reversely image-correcting unit 120, or decompensating unit 120, may reversely correct, or decompensate, first and second images, based on the correction data used to compensate the mask in order to create reversely corrected, or decompensated, first and second images as in FIG. 5. As shown in FIG. 5, the decompensated first and second images may have substantially the same shape. In exemplary embodiments in accordance with principles of inventive concepts, a decompensated image such as first decompensated image may be used as a reference image, for example.

In step ST240, inspecting unit 130 may compare decompensated second image with decompensated first image to determine whether the second die may be “normal” or not (that is, whether it will yield a designed pattern during a photolithographic step).

In exemplary embodiments in accordance with principles of inventive concepts, in step ST250, defect-detecting member 132 may detect a defect in a decompensated image.

In step ST260, CD-measuring member 134 may measure a CD of the mask pattern in a decompensated second die image. CD-measuring member 134 may determine a CD uniformity of a mask pattern based on measured CDs.

FIG. 6 is a flow chart illustrating a method in accordance with principles of inventive concepts of inspecting a mask using an apparatus such as that of FIG. 1. In step ST310, image-obtaining unit 110 may obtain an image of a die within a corrected, or pre-compensated, mask.

In exemplary embodiments in accordance with principles of inventive concepts, dies of the mask may have mask patterns having different shapes, in particular, of different designs. In such embodiments, dies within a mask may be compared to a reference die image that is a designed image.

In step ST320, decompensating unit 120 may decompensate an image based on compensation data to produce a decompensated image. In exemplary embodiments in accordance with principles of inventive concepts, a reference image, an image that may be used as a standard for comparison, may be a design image input into inspecting unit 130, for example.

In step ST330, inspecting unit 130 may compare a decompensated die image with a reference die image to determine whether the die may yield a desired pattern in a photolithographic operation.

In exemplary embodiments in accordance with principles of inventive concepts, in step ST340, defect-detecting member 132 may detect a defect in the decompensated image.

In step ST350, CD-measuring member 134 may measure a CD of a mask pattern in decompensated second image. The CD-measuring member 134 may obtain a CD uniformity of the mask pattern based on the measured CDs.

In exemplary embodiments in accordance with principles of inventive concepts, the mask may include a reflective EUV mask. Alternatively, these embodiments may be applied to other masks.

According to some exemplary embodiments in accordance with principles of inventive concepts, a corrected image of a mask, which may be corrected using the correction data, may be reversely corrected based on the correction data. Thus, the reversely corrected actual image may have a shape comparable with the reference image. That is, a compensated image of a mask may be compensated using correction data or compensation data, or may be decompensated using the compensation data and the decompensated image may be compared with a reference image.

The foregoing is illustrative of exemplary embodiments in accordance with principles of inventive concepts and is not to be construed as limiting thereof. Although a few exemplary embodiments in accordance with principles of inventive concepts have been described, those skilled in the art will readily appreciate that many modifications are possible in the exemplary embodiments in accordance with principles of inventive concepts without materially departing from the novel teachings and advantages of the present invention. Accordingly, all such modifications are intended to be included within the scope of the present invention as defined in the claims. It is to be understood that the foregoing is illustrative of various exemplary embodiments in accordance with principles of inventive concepts and is not to be construed as limited to the specific exemplary embodiments disclosed, and that modifications to the disclosed exemplary embodiments, as well as other exemplary embodiments, are intended to be included within the scope of the appended claims.

What is claimed is:

1. A method of inspecting a mask, the method comprising:
obtaining an image of a first die in a mask that is corrected based on correction data including deformation factors of an exposure process;
reversely correcting the image based on correction data; and
comparing the reversely corrected image with a reference image to determine whether the first die is normal or not.

2. The method of claim 1, wherein the correction data comprises:
data of horizontal-vertical (h-v) bias caused by a wavelength of an EUV light in the exposure process.

3. The method of claim 1, wherein the correction data comprises:
data of a flare of EUV light in the exposure process.

4. The method of claim 1, before obtaining the first actual image, further comprising:
obtaining a second image of a second die adjacent to the first die;
reversely correcting the second image based on the correction data; and
setting the reversely corrected second image as the reference image.

5. The method of claim 1, wherein the reference image comprises a design image of the mask.

6. The method of claim 1, wherein comparing the reversely corrected first image with the reference image comprises comparing to detect a defect in the reversely corrected first actual image.

7. The method of claim 1, wherein comparing the reversely corrected first image with the reference image comprises measuring a critical dimension (CD) uniformity of the reversely corrected first image.

8. The method of claim 1, wherein the mask comprises a reflective extreme ultraviolet (EUV) mask.

9. An apparatus for inspecting a mask, the apparatus comprising:
an image-obtaining unit for obtaining images of dies in a mask that is corrected based on correction data including deformation factors of an exposure process;
a reversely image-correcting unit for reversely correcting images based on the correction data; and
an inspecting unit for comparing reversely corrected images with a reference image to determine whether the dies are normal or not.

10. The apparatus of claim 9, wherein the inspecting unit comprises a defect-detecting member for detecting a defect in the reversely corrected actual images.

11. The apparatus of claim 9, wherein the inspecting unit comprises a CD-measuring member for measuring CDs of the reversely corrected actual images.

12. An apparatus comprising:
an imager configured to obtain an image of a die in a mask;
a decompensator configured to decompensate the image of the die; and
a comparator configured to compare the decompensated image of the die to a reference image.

13. The apparatus of claim 12 wherein the decompensator is configured to decompensate EUV compensated masks.

14. The apparatus of claim 12 wherein the decompensator is configured to decompensate h-v compensation.

15. The apparatus of claim 12 wherein the decompensator is configured to decompensate flare compensation.

16. The apparatus of claim 12 wherein the comparator is configured to compare a decompensated image to a reference represented by design data.

17. The apparatus of claim 12 wherein the comparator is configured to compare a decompensated image to a reference represented by a die image.
